(19) United States
(12) Patent Application Publication
(10) Pub. No.: US 2006/0092352 A1
(43) Pub. Date: May 4, 2006

(54) Liquid crystal display with oblique electrode assembly portions

(75) Inventor: Tze-Min Lin, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/263,499

(22) Filed: Oct. 31, 2005

(30) Foreign Application Priority Data
Oct. 29, 2004 (TW) 93132939

(51) Int. Cl. G02F 1/1333; G02F 1/1343

(52) U.S. Cl. 349/110; 349/141

(57) ABSTRACT

The present invention relates to a liquid crystal display with oblique electrode assembly portions. The liquid crystal display includes a first substrate, a second substrate opposite to the first substrate, and a plurality of liquid crystal molecules interposed therebetween. A plurality of gate lines (311) and data lines (312) are formed on the first substrate, thereby defining a plurality of pixel regions (P). Each pixel region includes a pixel electrode assembly (330) and a common electrode assembly (340) spaced apart from each other. The pixel electrode assembly includes a pixel line (332), a plurality of curved pixel electrodes (333), and a plurality of oblique portions (332a) where the curved pixel electrodes adjoin the pixel line. The common electrode assembly includes a common line (342), a plurality of curved common electrodes (343), and a plurality of oblique portions (342a) where the curved common electrodes adjoin the common line. The liquid crystal display has a high contrast ratio.

### FIELD OF THE INVENTION

The present invention relates to liquid crystal displays (LCDs), and more particularly to an in-plane switching (IPS) liquid crystal display.

### BACKGROUND

Recently, LCDs that are light and thin and have low power consumption characteristics have been widely used in office automation equipment, video units and the like. Such kinds of LCDs typically include a twisted nematic (TN) mode LCD and a super twisted nematic (STN) mode LCD. Although TN-LCDs and STN-LCDs have been put to practical use in many applications, they generally have a very narrow viewing angle. In order to solve the problem of narrow viewing angle, IPS LCDs have been developed.

A typical IPS LCD includes a plurality of pixel regions defined by a plurality of data lines and gate lines perpendicular to each other. FIG. 5 illustrates one pixel region P of a conventional IPS LCD 1. The pixel region P includes a gate line 113, a data line 115 and a common bus line 135 both substantially orthogonal to the gate line 113, a thin film transistor (TFT) 120 positioned at an intersection of the data line 115 and the gate line 113, and a pixel electrode assembly 131 and a common electrode assembly 133. The TFT 120 has a gate electrode, a source electrode, and a drain electrode, which are connected with the gate line 113, the data line 115, and the pixel electrode assembly 131 respectively. The pixel electrode assembly 131 and the common electrode assembly 133 are each generally comb-shaped. The common electrode assembly 133 includes a common line 133b and a plurality of gently zigzagged common electrodes 133a. A pixel electrode assembly 131 includes a pixel line 131b and a plurality of gently zigzagged pixel electrodes 131a. First portions of the zigzagged pixel electrodes 131a and the zigzagged common electrodes 133a are parallel to each other in a first direction to thereby define a first sub-electrode group. Second portions of the zigzagged pixel electrodes 131a and the zigzagged common electrodes 133a are parallel to each other in a second direction to thereby define a second sub-electrode group.

When a voltage is applied, because the pixel and common electrode assemblys 131, 133 have zigzagged structures, an electric field (not shown) generated is mainly along two directions. In the upper portion of FIG. 6, part of the first sub-electrode group is shown, and the lower portion of FIG. 6, part of the second sub-electrode group is shown. The liquid crystal molecules 130 in the upper and lower portions have different orientations, and the LCD exhibits a two-domain display effect. When viewing the LCD display from any oblique angle, color shifts generated by the two domains can counteract, and thus the overall color shift of the display is small.

However, at junctions of the first and second sub-electrode groups, the electric field is abnormal, and the liquid crystal molecules 130 thereat cannot be driven properly. In other words, a disclination of the liquid crystal molecules 130 is generated at the bends of the zigzagged electrodes 131a and 133a. Light thereat cannot transmit properly, and the contrast ratio of the pixel area P is lowered. Furthermore, the two-domain electrode configuration of the LCD inherently limits the display thereof. Equally good visual performance at various different viewing angles cannot be attained.

In addition, at junctions of the zigzagged pixel electrodes 131a and the pixel lines 131b, and at junctions of the zigzagged common electrodes 133a and the common lines 133b, the electric field is also abnormal, and the liquid crystal molecules thereat cannot be driven properly. As shown in FIG. 7, because the pixel electrode assembly 131 and the common electrode assembly 133 are spaced from each other, the electric field at the junctions of the zigzagged pixel electrode 131a and the pixel line 131b has a plurality of directions, which directions are substantially different from directions of the main electric field in the second sub-electrode group. Thus, the liquid crystal molecules 130a and 130b between the pixel line 131b and the common zigzagged electrode 133a have respective orientation directions, which directions are substantially different from orientation directions of the liquid crystal molecules 140a and 140b between the zigzagged pixel electrodes 131a and the zigzagged common electrode 133a. Therefore, at the aforesaid junctions, light thereat cannot transmit properly, and the contrast ratio of the pixel region P is lowered. Furthermore, the two-domain electrode configuration of the LCD inherently limits the display thereof. Equally good visual performance at various viewing angles cannot be attained.

What is needed, therefore, is a liquid crystal display panel which has an equally good visual performance at various different viewing angles and a high contrast ratio.

### SUMMARY

In a first preferred embodiment, a liquid crystal display includes a first substrate, a second substrate opposite to the first substrate, and a plurality of liquid crystal molecules interposed therebetween. A plurality of gate lines and data lines are formed on the first substrate, thereby defining a plurality of pixel regions. Each pixel region includes a pixel electrode assembly and a common electrode assembly spaced apart from each other. The pixel electrode assembly includes a pixel line, a plurality of curved pixel electrodes, and a plurality of oblique portions where the curved pixel electrodes adjoin the pixel line. The common electrode assembly includes a common line, a plurality of curved common electrodes, and a plurality of oblique portions where the curved common electrodes adjoin the common line.

In a second preferred embodiment, a liquid crystal display includes a pixel matrix substrate comprising a plurality of pixel regions. Each pixel region includes a pixel electrode assembly and a common electrode assembly spaced apart from each other. The pixel electrode assembly includes pixel base portion, at least one curved pixel portion, and a first oblique portion where the curved pixel portion adjoins the pixel base portion. The common electrode assembly includes a common base portion, at least one curved common portion, and a second oblique portion where the curved common portion adjoins the common base portion.

In the liquid crystal display of the first preferred embodiment, because the pixel electrode assembly has the curved pixel electrodes and the common electrode assembly has the curved common electrodes, the pixel and common electrode assemblys do not have sharp bends. Accordingly, disclination of liquid crystal molecules is avoided. Further, because oblique portions are provided at junctions of the curved pixel electrodes and the pixel line and at junctions of the curved common electrodes and the common line, when a voltage is applied, an electric field near the oblique portions has a smooth continuum of gradually changing directions. Thus, the liquid crystal molecules have smoothly changing orientation directions along the lengths of the respective pixel and common electrodes. Accordingly, light at the oblique portions can transmit properly. Equally good visual performance at various viewing angles can be attained. Therefore the liquid crystal display has a high contrast ratio.

In the liquid crystal display of the second preferred embodiment, because the pixel electrode assembly has at least one curved pixel portion and the common electrode assembly has at least one curved common portion, the pixel and common electrode assemblys do not have sharp bends. Accordingly, disclination of liquid crystal molecules is avoided. Further, because oblique portions are provided at junctions of the curved pixel portion and the pixel common portion and at junctions of the curved common portion and the common base portion, when a voltage is applied, an electric field near the oblique portions has a smooth continuum of gradually changing directions. Thus, the liquid crystal molecules have smoothly changing orientation directions along the lengths of the respective pixel and common electrodes. Accordingly, light at the oblique portions can transmit properly. Equally good visual performance at various viewing angles can be attained. Therefore the liquid crystal display has a high contrast ratio.

Other advantages and novel features will become more apparent from the following detailed description when taken in conjunction with the accompanying drawings, in which:

### BRIEF DESCRIPTION OF THE DRAWINGS

FIG. 1 is a schematic, cross-sectional top plan view of a pixel region of an IPS LCD according to a first preferred embodiment of the present invention;

FIG. 2 is an enlarged view of a circled portion II of FIG. 1, showing approximate orientations of liquid crystal molecules near a oblique portion;

FIG. 3 is a schematic, cross-sectional top plan view of a pixel region of an IPS LCD according to a second preferred embodiment of the present invention;

FIG. 4 is a schematic, cross-sectional top plan view of a pixel region of an IPS LCD according to a third preferred embodiment of the present invention;

FIG. 5 is a schematic, cross-sectional top plan view of a pixel region of a conventional IPS LCD;

FIG. 6 is an enlarged view of a circled portion VI of FIG. 5, showing approximate orientations of liquid crystal molecules near junctions of a first sub-electrode group and a second sub-electrode group; and

FIG. 7 is an enlarged view of a circled portion VII of FIG. 5, showing approximate orientations of liquid crystal molecules between a zigzagged common electrode and a pixel line.

### DETAILED DESCRIPTION OF PREFERRED EMBODIMENTS

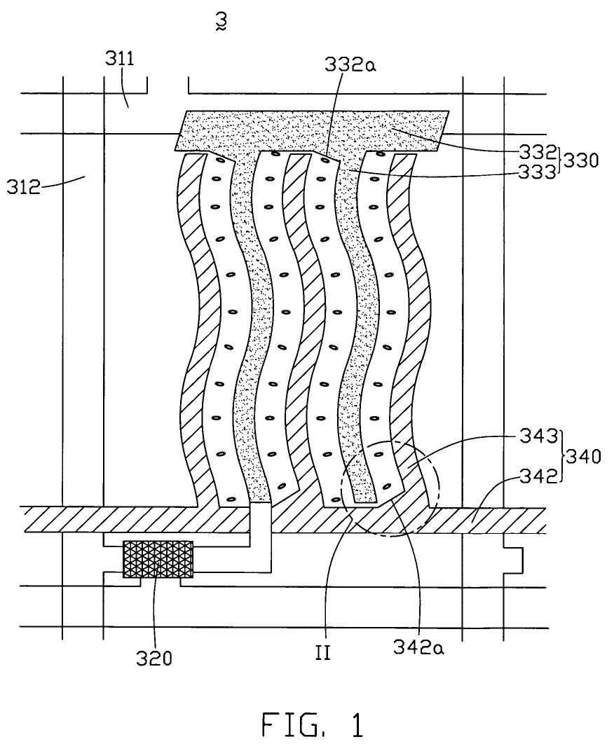

Referring to FIG. 1, an IPS LCD 3 according to a first preferred embodiment of the present invention includes a first substrate (not shown), a second substrate (not shown) opposite to the first substrate, and a plurality of liquid crystal molecules interposed between the first and second substrates. As shown in FIG. 1, the IPS LCD 3 further includes a plurality of gate lines 311 and a plurality of data lines 312 formed on the first substrate, thereby defining a plurality of pixel regions. Each pixel region includes a TFT 320 positioned at an intersection of the data line 312 and the gate line 311, a pixel electrode assembly 330, and a common electrode assembly 340. The TFT 320 has a gate electrode, a source electrode, and a drain electrode, which are connected to the gate line 311, the data line 312, and the pixel electrode assembly 330 respectively.

The pixel electrode assembly 330 and the common electrode assembly 340 are each comb-shaped, and are spaced apart from each other. The common electrode assembly 340 includes a common line 342, and a plurality of curved common electrodes 343. The pixel electrode assembly 330 includes a pixel line 332, and a plurality of curved pixel electrodes 333. An oblique portion 342a is provided at one side of each curved common electrode 343 where the curved common electrode 343 adjoins the common line 342. The oblique portion 342a integrally interconnects the curved common electrode 343 and the common line 342, and is adjacent the end of a corresponding curved pixel electrode 333. An oblique portion 332a is provided at one side of each curved pixel electrode 333 where the curved pixel electrode 333 adjoins the pixel line 332. The oblique portion 332a integrally interconnects the curved pixel electrode 333 and the pixel line 332, and is adjacent the end of a corresponding curved common electrode 343. Because each of the oblique portions 332a and 342a is located at a junction of a respective common/pixel electrode and a respective common/pixel line, each oblique portion 332a and 342a can be considered to be a so-called junction chamfer.

When a voltage is applied at the pixel region, because the pixel electrode assembly 330 has the curved pixel electrodes 333 and the common electrode assembly 340 has the curved common electrodes 343, the pixel electrode assembly 330 and the common electrode assembly 340 do not have sharp bends, and an electric field generated by the pixel electrode assembly 330 and the common electrode assembly 340 is a smooth continuum of gradually changing domains. Accordingly, disclination manifest in the above-described conventional IPS LCD 1 is avoided.

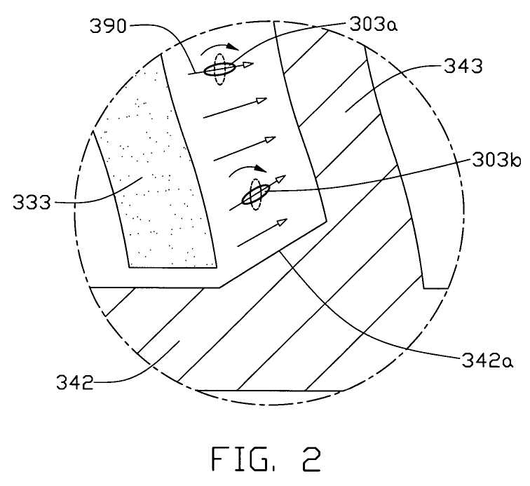

Further, referring to FIG. 2, because a oblique portion 342a is provided at a junction of each curved common electrode 343 and the common line 342, the space between the curved common electrode 343 and the corresponding adjacent curved pixel electrode 333 in the region of the oblique portion 342a is substantially uniform. This means that an electric field 390 generated near the oblique portion 342a has a smooth continuum of gradually changing directions. Thus, liquid crystal molecules 303b near the oblique portion 342a and liquid crystal molecules 303a far away from the oblique portion 342a all have smoothly changing orientation directions along the space between the pixel and common electrodes 333, 343. Accordingly, light near the oblique portion 342a can transmit properly. For similar reasons, light near each oblique portion 332a can transmit properly. Equally good visual performance at various viewing angles of the IPS LCD 3 can be attained. Therefore the IPS LCD 3 has a higher contrast ratio than the conventional IPS LCD 1.

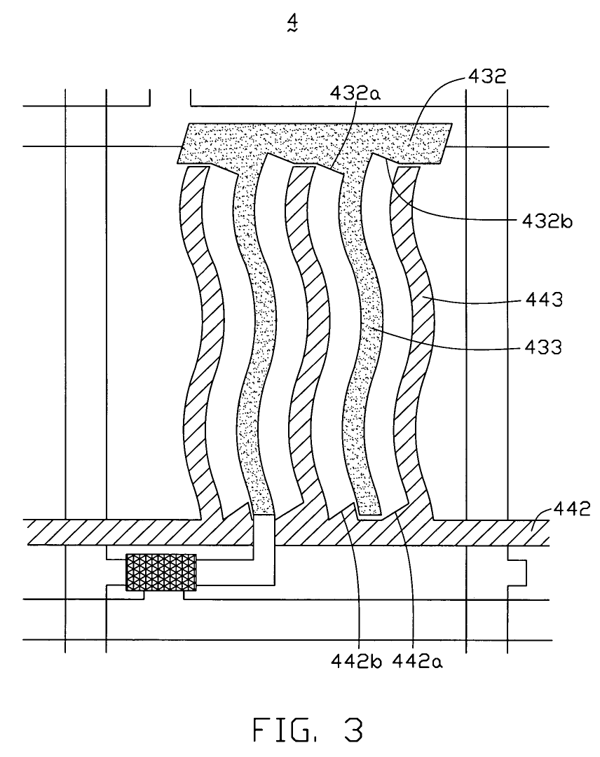

Referring to FIG. 3, an IPS LCD 4 according to a second preferred embodiment of the present invention is shown. The IPS LCD 4 is similar to the IPS LCD 3. However, the IPS LCD 4 includes an oblique portion 442a provided at a first side of each of curved common electrodes 443 where the curved common electrode 443 adjoins a common line 442, with the oblique portion 442a being adjacent one side of an end of a corresponding curved pixel electrode 433; and an oblique portion 442b provided at a second side of an adjacent curved common electrode 443 where the curved common electrode 443 adjoins the common line 442, with the oblique portion 442b being adjacent an opposite side of the end of the same corresponding curved pixel electrode 433. The IPS LCD 4 further includes an oblique portion 432a provided at a first side of each curved pixel electrode 433 where the curved pixel electrode 433 adjoins a pixel line 432, with the oblique portion 432a being adjacent one side of an end of a corresponding curved common electrode 443; and an oblique portion 432b provided at a second side of an adjacent curved pixel electrode 433 where the curved pixel electrode 433 adjoins the pixel line 432, with the oblique portion 432b being adjacent an opposite side of the end of the same corresponding curved common electrode 443. That is, each pair of oblique portions 442a and 442b is arranged at two sides of the end of the corresponding curved common electrode 443; and each pair of oblique portions 432a and 432b is arranged at two sides of the end of the corresponding curved pixel electrode 433. The oblique portions 442a, 442b, 432a, 432b, are all so-called junction chamfers.

For reasons similar to the those described above in relation to the oblique portions 332a and 342a of the IPS LCD 3, light can transmit properly near the oblique portions 442a, 442b, 432a, 432b of the IPS LCD 4. Equally good visual performance at various viewing angles can be attained. Therefore the IPS LCD 4 has a higher contrast ratio than the conventional IPS LCD 1. Further, because the IPS LCD 4 has more oblique portions than the IPS LCD 3, the IPS LCD 4 has a higher contrast ratio than the IPS LCD 3.

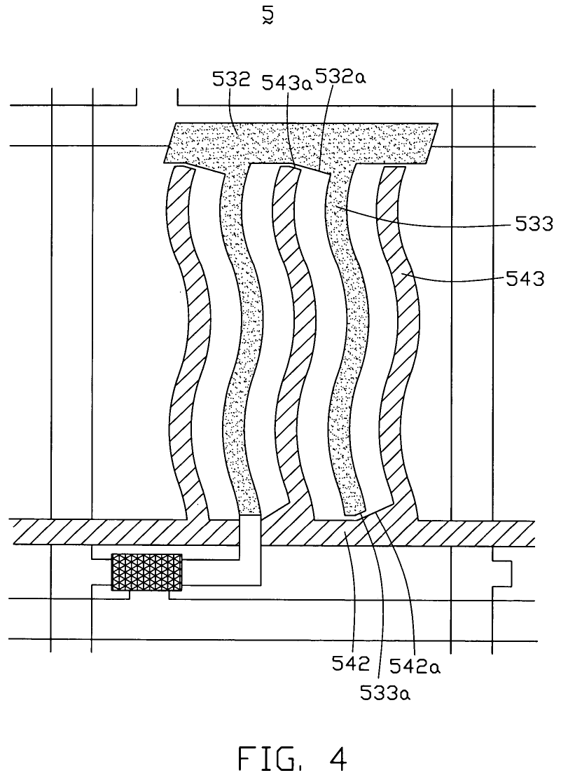

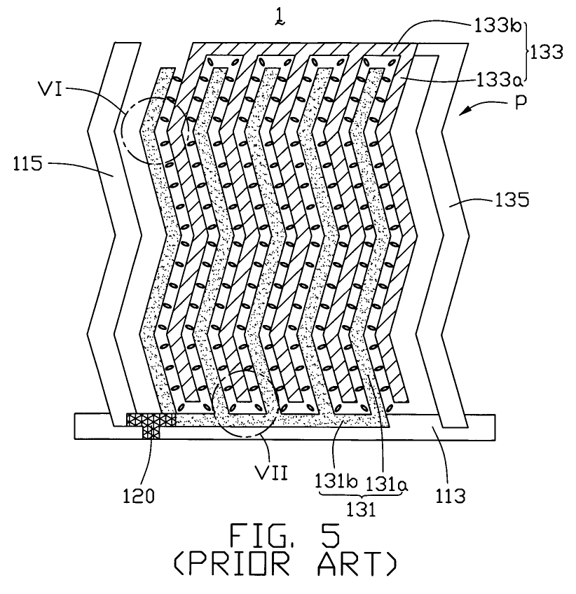

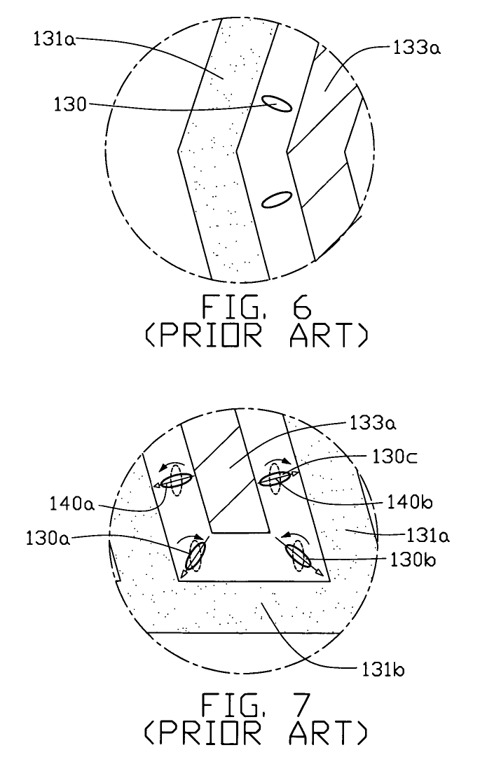

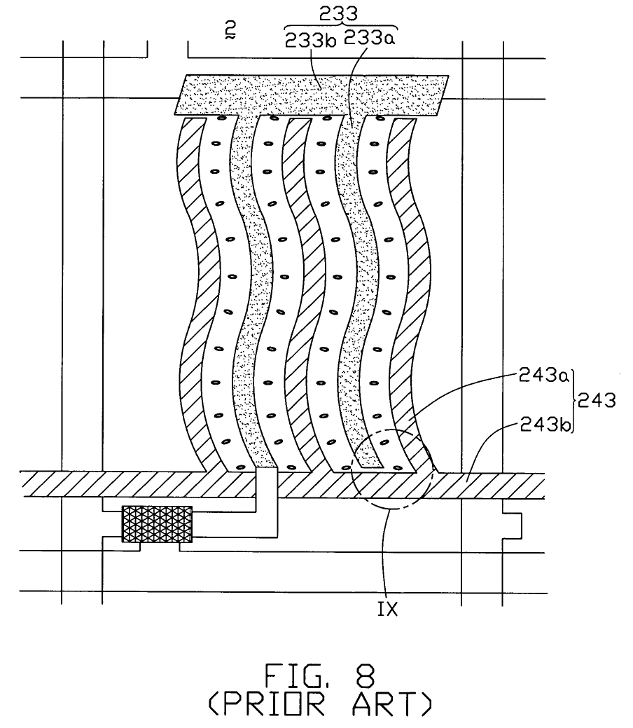

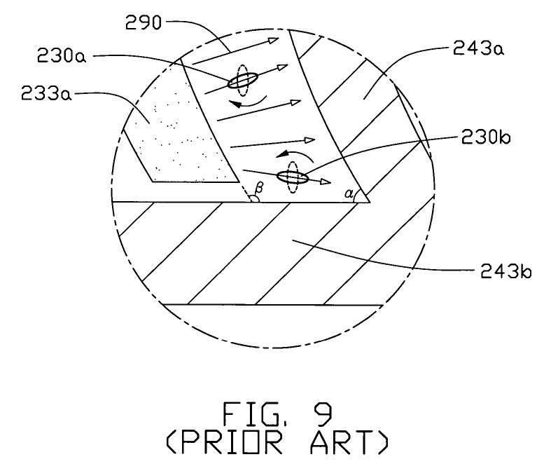

Referring to FIG. 4, an IPS LCD 5 according to a third preferred embodiment of the present invention is shown. The IPS LCD 5 is similar to the IPS LCD 3. In the IPS LCD 5, an oblique portion 542a provided at one side of each of curved common electrodes 543 where the curved common electrode 543 adjoins a common line 542. The oblique portion 542a integrally interconnects the curved common electrode 343 and the common line 342, and is adjacent the end of a corresponding curved pixel electrode 533. An oblique portion 533a is provided at the end of the curved pixel electrode 533, and is shaped to correspond to the oblique portion 542a. That is, oblique portions 542a, 533a oppose each other, and are spaced a uniform distance apart. An oblique portion 532a provided at one side of each curved pixel electrode 533 where the curved pixel electrode 533 adjoins a pixel line 532. The oblique portion 532a integrally interconnects the curved pixel electrode 533 and the pixel line 532, and is adjacent the end of a corresponding curved common electrode 543. An oblique portion 543a is provided at the end of the curved common electrode 543, and is shaped to correspond to the oblique portion 532a. That is, oblique portions 532a, 543a oppose each other, and are spaced a uniform distance apart. The oblique portions 542a and 532a are junction chamfers. Each of the oblique portions 533a and 543a can be considered to be a so-called end chamfer.

For reasons similar to those described above in relation to the oblique portions 332a and 342a of the IPS LCD 3, light can transmit properly near the oblique portions 542a, 533a, 532a, 543a of the IPS LCD 5. Equally good visual performance at various viewing angles can be attained. Therefore the IPS LCD 5 has a higher contrast ratio than the conventional IPS LCD 1. Further, because the IPS LCD 5 has the more oblique portions than the IPS LCD 3, the IPS LCD 5 has a higher contrast ratio than the IPS LCD 3.

It is to be understood, however, that even though numerous characteristics and advantages of various embodiments of the present invention have been set forth in the foregoing description, together with details of the structures and functions of the embodiments, the disclosure is illustrative only, and changes may be made in detail to the full extent indicated by the broad general meaning of the terms in which the appended claims are expressed.

What is claimed is:

1. A liquid crystal display, comprising:
a first substrate;
a second substrate opposite to the first substrate;
a plurality of liquid crystal molecules interposed between the first and second substrates; and
a plurality of gate lines and data lines formed on the first substrate, thereby defining a plurality of pixel regions; each pixel region comprising:
a pixel electrode assembly, comprising a pixel line, at least one curved pixel electrode, and a first oblique portion where the curved pixel electrode adjoins the pixel line; and
a common electrode assembly spaced apart from the pixel electrode assembly, comprising a common line, at least one curved common electrode, and a second oblique portion where the curved common electrode adjoins the common line.

2. The liquid crystal display as recited in claim 1, further comprising a third oblique portion where the curved pixel electrode adjoins the pixel line, the third oblique portion being at a side of the curved pixel electrode opposite from the first oblique portion.

3. The liquid crystal display as recited in claim 1, further comprising a fourth oblique portion where the curved common electrode adjoins the common line, the third oblique portion being at a side of the curved common electrode opposite from the second oblique portion.

4. The liquid crystal display as recited in claim 1, further comprising a fifth oblique portion at an end of at least one curved common electrode that is adjacent to the first oblique portion.

5. The liquid crystal display as recited in claim 4, wherein the fifth oblique portion is shaped to correspond to the first oblique portion.

6. The liquid crystal display as recited in claim 1, further comprising a sixth oblique portion at an end of at least one curved pixel electrode that is adjacent to the second oblique portion.

7. The liquid crystal display as recited in claim 6, wherein the sixth oblique portion is shaped to correspond to the second oblique portion.

8. A liquid crystal display, comprising: a pixel matrix substrate comprising a plurality of pixel regions, each pixel region comprising:
a pixel electrode assembly, comprising a pixel base portion, at least one curved pixel portion, and a first oblique portion where the curved pixel portion adjoins the pixel base portion; and
a common electrode assembly spaced apart from the pixel electrode assembly, comprising a common base portion, at least one curved common portion, and a second oblique portion where the curved common portion adjoins the common base portion.

9. The liquid crystal display as recited in claim 8, wherein the first oblique portion is arranged at one side of the curved pixel portion.

10. The liquid crystal display as recited in claim 8, wherein each pixel region comprises at least a pair of the first oblique portions, which are arranged at two opposite sides of the curved pixel portion.

11. The liquid crystal display as recited in claim 8, wherein the second oblique portion is arranged at one side of the curved common portion.

12. The liquid crystal display as recited in claim 8, wherein each pixel region comprises at least a pair of the second oblique portions, which are arranged at two opposite sides of the curved common portion.

13. The liquid crystal display as recited in claim 8, further comprising a third oblique portion positioned at an end of the curved pixel portion far away from the pixel bottom portion.

14. The liquid crystal display as recited in claim 13, wherein the third oblique portion is shaped to correspond to the first oblique portion.

15. The liquid crystal display as recited in claim 8, further comprising a fourth oblique portion positioned at an end of the curved common portion far away from the common bottom portion.

16. The liquid crystal display as recited in claim 15, wherein the fourth oblique portion is shaped to correspond to the second oblique portion.

17. A liquid crystal display comprising:
a pixel matrix substrate comprising a plurality of pixel regions, each pixel region comprising:
a pixel electrode assembly comprising a pixel base portion, and at least one curved pixel portion extending therefrom; and
a common electrode assembly comprising a common base portion spaced from the pixel base portion in a first direction, and at least one curved common portion extending therefrom under a condition that the curved pixel portion extends toward the common base portion and the curved common portion extends toward the pixel base portion under a close and compliant relation with the curved pixel portion in a second direction perpendicular to said first direction; wherein
one oblique portion is formed around a joint portion of the curved common portion and the common base portion or that of the curved pixel portion and the pixel base portion.

18. The liquid crystal display as claimed in claim 17, wherein the oblique portion extends in a direction which is roughly perpendicular to a tangent line of the corresponding curved common portion or curved pixel portion.

19. The liquid crystal display as claimed in claim 17, wherein there are a plurality of said at least one curved common portion and a plurality of said at least one curved pixel portion interwoven with each other along said second direction.

20. The liquid crystal display as claimed in claim 17, wherein only one said oblique portion is formed around said joint portion.
